(19) United States
(12) Patent Application Publication
(10) Pub. No.: US 2004/0203407 A1
(43) Pub. Date: Oct. 14, 2004

(54) Radio computer monitor transmitting receiving control apparatus

(76) Inventor: Wen-Hung Chang, Hsinchu City (TW)

Correspondence Address: VARNDELL & VARNDELL, PLLC, 106-A S. COLUMBUS ST., ALEXANDRIA, VA, 22314, US

(21) Appl. No.: 10/167,616

(22) Filed: Jun. 13, 2002

(51) Int. Cl. H04B 7/00

(52) U.S. Cl. 455/66.1; 455/41.2

(57) ABSTRACT

A radio computer monitor transmitting receiving control apparatus is constructed to include at least one receiving module respectively installed in a respective audio video signal output device, for example, a computer monitor, television, liquid crystal display, or organic light emitting diode display controlled by a remote controller, and a radio transmitting control module connected to an audio video signal source, which can be a host computer or set-top-box, and adapted for transmitting signal data received from the remote controller through one receiving module to the audio video signal source and transmitting audio video output signal from the audio video signal source to each receiving module for output through each monitor in which one of the at least one receiving module is installed.

### BACKGROUND AND SUMMARY OF THE INVENTION

The present invention relates to a radio computer monitor transmitting receiving control apparatus, which enables multiple computer monitors to be worked with one host computer by radio.

A family may have several computer systems installed in different rooms or floors for different members of the family. It is expensive to install several computer systems in the house. If there is only one computer system provided at a particular location in the house of a family, the members of the family cannot use the computer system at the same time. Further, it is inconvenient to different members of the family to use the computer system.

The present invention has been accomplished under the circumstances in view. It is the main object of the present invention to provide a computer monitor transmitting receiving control apparatus, which enables a plurality of audio video output devices to be worked with a host computer or set-top-box by radio. According to the radio computer monitor transmitting receiving control apparatus comprises at least one receiving module respectively installed in a respective audio video output device controlled by a remote controller, and a radio transmitting control module connected to a host computer or set-top-box adapted for transmitting output signal from the host computer or set-top-box to each receiving module by radio for output through the respective audio video output device. Each receiving module each comprises a wireless control signal transceiver controlled by the remote controller to transmit signal data to the host computer or set-top-box through the radio transmitting control module, and a radio audio video receiver adapted for receiving audio video signals from the host computer or set-top-box through the radio transmitting control module for output through the audio video output device in which the respective receiving module is installed. The radio transmitting control module comprises a circuit control panel having installed therein a digital analog converter for converting digital signal into analog signal, a radio audio video transmitter for transmitting audio video signals to each receiving module by radio, and a wireless control signal transceiver for signal data transmission between each receiving module and the host computer or set-top-box

### BRIEF DESCRIPTION OF THE DRAWINGS

FIG. 1 is a plain view showing the arrangement of a radio computer monitor transmitting receiving control apparatus according to the present invention.

FIG. 2 is a system block diagram of the radio computer monitor transmitting receiving control apparatus according to the present invention.

FIG. 3 is a schematic drawing showing an application example of the present invention.

### DETAILED DESCRIPTION OF THE PREFERRED EMBODIMENT

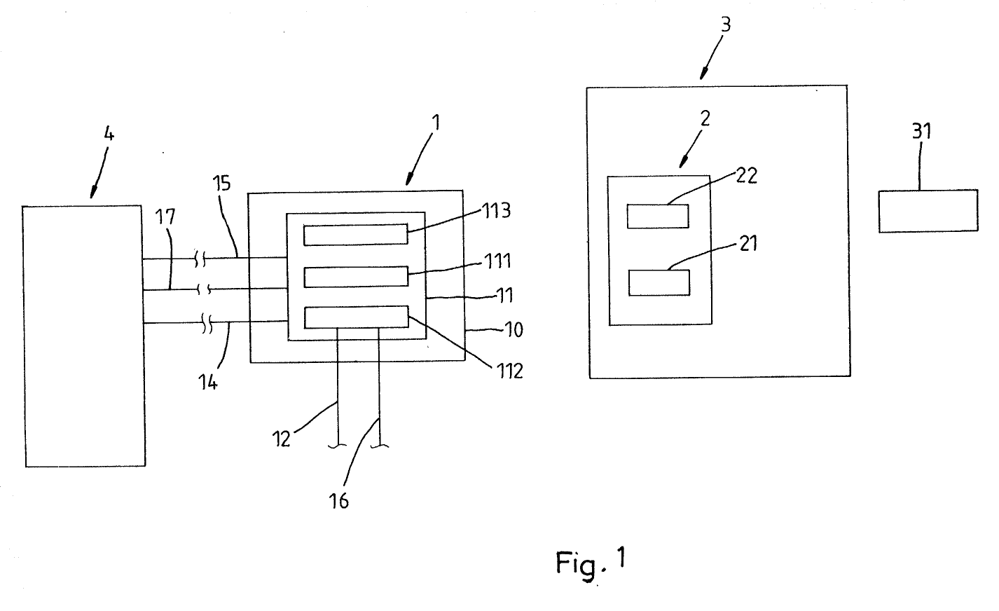

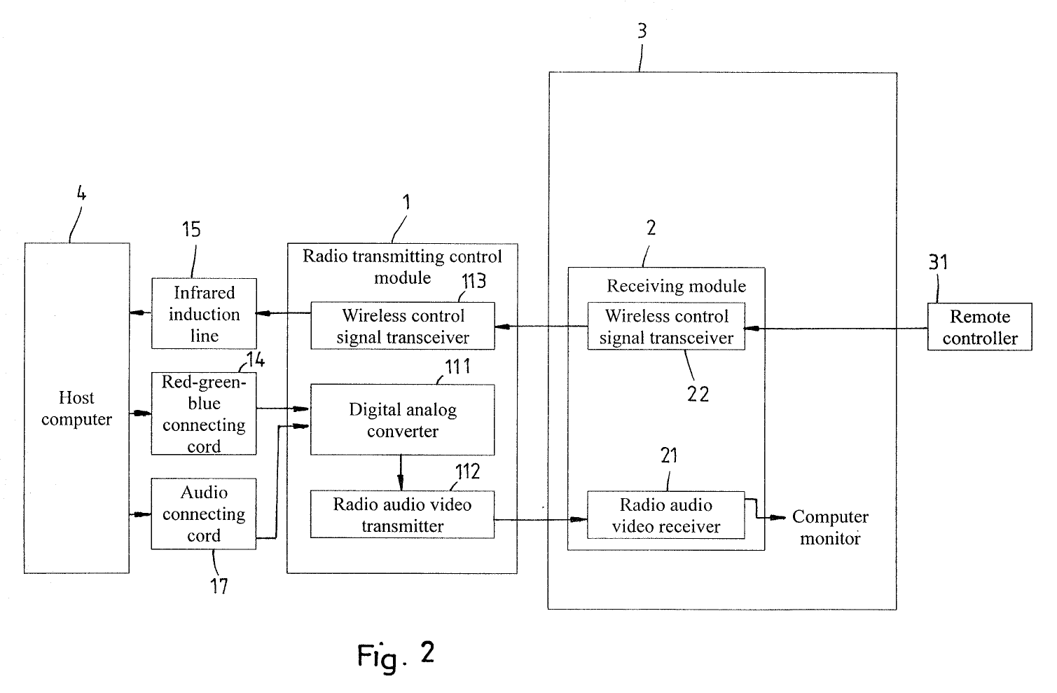

Referring to FIGS. 1 and 2, a radio computer monitor transmitting receiving control apparatus in accordance with the present invention is shown comprised of a radio transmitting control module 1 connected to a host computer 4, and a receiving module 2 installed in a computer monitor 3.

The radio transmitting control module 1 comprises a circuit control panel 11 having installed therein a digital analog converter 111, a radio audio video transmitter 112, and a wireless control signal transceiver 113. The digital analog converter 111 is adapted for converting analog signal into digital signal and digital signal into analog signal. The radio audio video transmitter 112 is controlled to transmit audio video signals to the radio audio video receiver unit 21 of the receiving module 2 in the computer monitor 3 at the frequency of 1.8 G˜2.4 G or 2.4 G˜3.0 G or 5.1 G˜6.0 G. The wireless control signal transceiver 113 is adapted to receive signal data from the wireless control signal transceiver 22 of the receiving module 2 in the computer monitor 3.

The radio transmitting control module 1 further comprises a case 10, which receives the circuit control panel 11. By means of the case 10, a cable 12 and a power cord power cord 16 can conveniently connected to the circuit control panel 11 of the radio transmitting control module 1. Further, the circuit control panel 11 has a red-green-blue video connecting cord 14, an audio connecting cord 17 and an infrared induction line 15 respectively connected to the host computer 4. Photoelectric sensors may be respectively installed in the circuit control panel 11 and the host computer 4 for signal data transmission from the wireless control signal transceiver 113 to the host computer 4 instead of the infrared induction line 15.

The radio audio video receiver unit 21 of the receiving module 2 is adapted to receive signal from the radio audio video transmitter 112 of the radio transmitting control module 1 for audio and video input. The wireless control signal transceiver 22 of the receiving module 2 is adapted to receive signal data from the remote controller (or wireless keyboard) 31 of the computer monitor 3, and then to transmit received signal data to the wireless control signal transceiver 113 of the radio transmitting control module 1 by infrared.

When the wireless control signal transceiver 22 of the receiving module 2 received signal data from the remote controller (wireless keyboard) 31 of the computer monitor 3, the wireless control signal transceiver 22 immediately transmits received signal data to the wireless control signal transceiver 113 of the radio transmitting control module 1 by infrared, the wireless control signal transceiver 113 of the radio transmitting control module 1 in turn transmits received signal data to the host computer 4 through the infrared induction line 15, thereby causing the host computer 4 to transmit computer digital signal to the digital analog converter 111 of the radio transmitting control module 1 through the red-green-blue video connecting cord 14 and the audio connecting cord 17. The digital analog converter 111 converts received digital computer audio video signals into analog signals, enabling converted audio video analog signals to be transmitted by the radio audio video transmitter 112 to the radio audio video receiver unit 21 of the receiving module 2 in the computer monitor 3 by radio at the frequency of 1.8 G˜6.0 G for audio video output through the computer monitor 3.

As an alternate form of the present invention, the receiving module 2 can be installed in a liquid crystal display, cathode ray tube television, projector, plasma television, organic light emitting diode display, or any of a variety of audio video output devices instead of the computer monitor 3, and the radio transmitting control module 1 can be installed in a set-top-box (which provides digital video disk, Internet phone and home security functions) instead of the host computer 4.

The receiving module 2 is installed in the computer monitor 3 during the fabrication of the computer monitor 3. The remote controller (wireless keyboard, wireless mouse, or wireless joystick) 31 is provided to the consumer buying the computer monitor 3. The radio transmitting control module 1 is also provided to the consumer buying the computer monitor 3 and the host computer 4. The radio transmitting control module 1 can also be directly installed in the host computer 4 or set-top-box. The radio transmitting control module 1 and the receiving module 2 may be separately made and sold to the consumers.

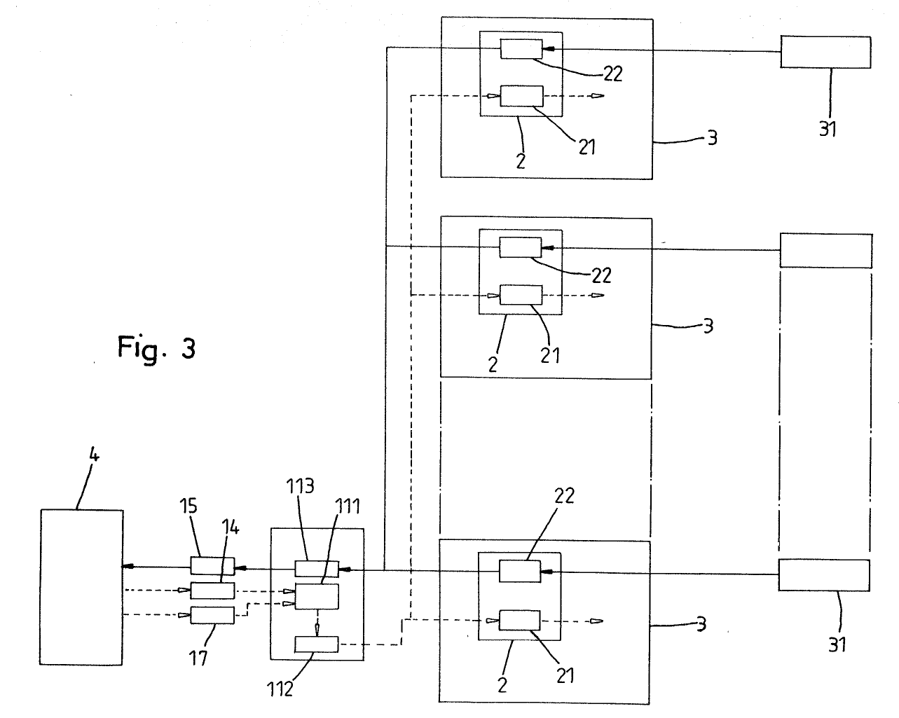

Referring to FIG. 3, several computer monitors 3 that are respectively provided with a receiving module 2 can be controlled by one single or a respective remote controller 31 for output of radio audio video signals from a host computer 4, which has a radio transmitting control module 1 connected thereto or installed therein.

A prototype of radio computer monitor transmitting receiving control apparatus has been constructed with the features of the annexed drawings of FIGS. 1-3. The radio computer monitor transmitting receiving control apparatus functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

1. A radio computer monitor transmitting receiving control apparatus comprising:
at least one receiving module respectively installed in a respective audio video output device controlled by a remote controller, said at least one receiving module each comprising a wireless control signal transceiver controlled by said remote controller to transmit signal data, and a radio audio video receiver adapted for receiving audio video signals from an external source for output through the audio video output device in which the respective receiving module is installed; and
a radio transmitting control module connected to an audio video signal source and adapted for transmitting output signal from said audio video signal source to each of said at least one receiving module for output through each audio video output device in which one of said at least one receiving module is installed, said radio transmitting control module comprising a circuit control panel having installed therein a digital analog converter, a radio audio video transmitter, and a wireless control signal transceiver, said digital analog converter being connected to said audio video signal source by a red-green-blue video connecting cord and an audio connecting cord and adapted for converting digital signal into analog signal for output through said radio audio video transmitter, said radio audio video transmitter being adapted to transmit audio video signals from said digital analog converter to the radio audio video receiver of each of said at least one receiving module at the frequency of 1.8 G˜6.0 G for output through the respective audio video output device, the wireless control signal transceiver of said radio transmitting control module being adapted to receive signal data from the wireless control signal transceiver of each of said at least one receiving module and to transmit received signal data to said audio video signal source for driving said video signal source to operate.

2. The radio computer monitor transmitting receiving control apparatus as claimed in claim 1, wherein said audio video output device is a television.

3. The radio computer monitor transmitting receiving control apparatus as claimed in claim 1, wherein said audio video output device is a liquid crystal display.

4. The radio computer monitor transmitting receiving control apparatus as claimed in claim 1, wherein said audio video output device is an organic light emitting diode display.

5. The radio computer monitor transmitting receiving control apparatus as claimed in claim 1, wherein said remote controller is a wireless keyboard.

6. The radio computer monitor transmitting receiving control apparatus as claimed in claim 1, wherein said remote controller is a wireless mouse.

7. The radio computer monitor transmitting receiving control apparatus as claimed in claim 1, wherein said audio video output device is a wireless joystick.

8. The radio computer monitor transmitting receiving control apparatus as claimed in claim 1, wherein said radio audio video transmitter is controlled to transmit audio video signals at the frequency of 1.8 G˜2.4 G.

9. The radio computer monitor transmitting receiving control apparatus as claimed in claim 1, wherein said radio audio video transmitter is controlled to transmit audio video signals at the frequency of 2.4 G˜3.0 G.

10. The radio computer monitor transmitting receiving control apparatus as claimed in claim 1, wherein said radio audio video transmitter is controlled to transmit audio video signals at the frequency of 5.1 G˜6.0 G.

11. The radio computer monitor transmitting receiving control apparatus as claimed in claim 1, wherein said radio television and frequency modulation transmitter unit is controlled to transmit television and frequency modulation signal at the frequency of 2.4 G˜3.0 G.

12. The radio computer monitor transmitting receiving control apparatus as claimed in claim 1, wherein the audio video signal source in which said radio transmitting control module is installed in a host computer

13. The radio computer monitor transmitting receiving control apparatus as claimed in claim 1, wherein the audio video signal source in which said radio transmitting control module is installed in a set-top-box.

14. The radio computer monitor transmitting receiving control apparatus as claimed in claim 1, wherein the wireless control signal transceiver of said radio transmitting control module is connected to said audio video signal source by an infrared induction line.

15. The radio computer monitor transmitting receiving control apparatus as claimed in claim 1, wherein the wireless control signal transceiver of said radio transmitting control module is disposed in communication with said audio video signal source by a first photoelectric sensor installed in the wireless control signal transceiver of said radio transmitting control module and a second photoelectric sensor installed in said audio video signal source.
